(19) United States
(12) Patent Application Publication
(10) Pub. No.: US 2008/0272211 A1
(43) Pub. Date: Nov. 6, 2008

(54) PROCESS FOR THE GASIFICATION OF TAP WATER

(75) Inventors: Michael Rann, Hamburg (DE); Joakim Trumpler, Lubeck (DE)

Correspondence Address: MORRISON & FOERSTER LLP, 1650 TYSONS BOULEVARD, SUITE 400, MCLEAN, VA, 22102, US

(73) Assignee: DS Produkte Dieter Schwarz GmbH, Stapelfeld (DE)

(21) Appl. No.: 12/043,027

(22) Filed: Mar. 5, 2008

(30) Foreign Application Priority Data
May 5, 2007 (DE) 20 2007 003 204.8

(51) Int. Cl. B05B 7/32; B01F 3/04; B05B 7/26

(52) U.S. Cl. 239/410; 261/76; 239/412

(57) ABSTRACT

The invention relates to an apparatus for the gas treatment of mains water in the inflow of a domestic fitting (16), having a connection (12) for a gas source, and having a device (8) for supplying the gas into the mains-water stream. The invention provides the following features:
a. the apparatus is designed as a unit which is capable of forming part of the substructure and has a watery inlet, a gas inlet and an outlet for the water or gas-treated water,
b. it has a pressure sensor (4) which is assigned to the water main and is designed for emitting a first control signal when the water pressure drops below a predetermined threshold value,
c. it has a control unit which is intended for releasing the gas supply and is designed for activating the device for supplying the gas into the mains-water stream as soon as it has received the first control signal from the pressure sensor and an additional, second control signal.

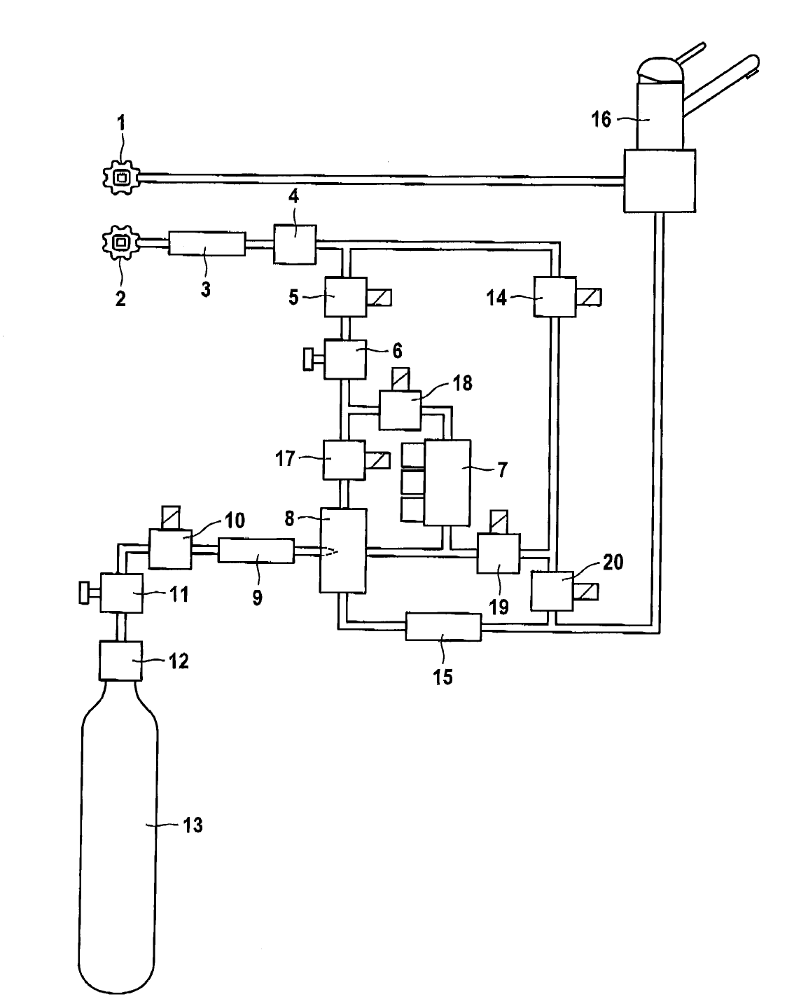

The invention relates to an apparatus for the gas treatment of mains water in the inflow of a domestic fitting, having a connection for a gas source, and having a device for supplying the gas into the mains-water stream.

The supply of gas into mains water, in particular the carbonation of mains water using CO₂, is known from prior public usage. Carbon-dioxide-containing fizzy water is produced in this way from mains water. This usually takes place in portions (bottle by bottle) in a corresponding carbonator.

It is likewise known from prior public usage to install a carbonator in the inflow of a mains-water faucet, in which case carbonated mains water passes out of this water faucet once it has been opened.

The object of the invention is to provide an apparatus of the type mentioned in the introduction which is easy to handle and versatile in use and allows existing domestic fittings to be retrofitted with low outlay for the purpose of gas treatment of the mains water.

The invention achieves this object, in the case of an apparatus according to the preamble of claim 1, by the following features:
a. the apparatus is designed as a unit which is capable of forming part of the substructure and has a watery inlet, a gas inlet and an outlet for the water or gas-treated water,
b. it has a pressure sensor which is assigned to the water main and is designed for emitting a first control signal when the water pressure drops below a predetermined threshold value,
c. it has a control unit which is intended for releasing the gas supply and is designed for activating the device for supplying the gas into the mains-water stream as soon as it has received the first control signal from the pressure sensor and an additional, second control signal.

First of all, some of the terms used within the context of the invention should be explained. The term domestic fitting covers any conventional water-tap connection for the household sector, gastronomy and industrial catering.

The apparatus is designed for the gas treatment of mains water in the inflow of this domestic fitting. This means that, when the apparatus is activated, the mains water passes out of the fitting in an already gas-treated state.

The apparatus has a device for supplying the gas into the mains-water stream. This means that, with the fitting open, the gas supply can take place as the water flows. The formulation does not rule out the use of mixing vessels such as, for example, effervescing chambers, carbonating chambers or the like.

The apparatus according to the invention is designed as a unit which is capable of forming part of the substructure. This means that the dimensions of this unit are sufficiently small in order to allow it to be installed in the region beneath a domestic fitting installed at the conventional height, for example in the cabinet beneath a sink.

The pressure sensor provided is assigned to a water main, preferably to a water-main portion arranged within the unit which is capable of forming part of the substructure, preferably a portion upstream of that location of the water main at which the gas is supplied. “Assigned” means that it is designed for measuring the water pressure in this water-main portion.

The control unit for releasing the gas supply only releases this gas supply when it has received both the first control signal from the pressure sensor and an additional, second control signal. This can take place, for example, in the form of an AND circuit known from the prior art.

The apparatus according to the invention can be integrated in an existing domestic water installation and, once it has been installed, allows water which has not been gas-treated or water which has been gas-treated to be optionally discharged from the domestic fitting.

If the valve or the faucet of the domestic fitting is opened, the water pressure in the water-supply line drops. The predetermined threshold value of the pressure sensor is set such that the water pressure drops below this threshold value when the water faucet is opened (possibly even just when the water faucet is opened as from a certain minimum throughflow quantity) and the pressure sensor thus emits the first control signal during this opening of the water faucet.

This first control signal is a necessary, albeit not inherently sufficient, condition for triggering the gas supply. This first control signal ensures that gas supply can take place basically only when the water faucet is opened.

In order that gas treatment nevertheless actually takes place when the water faucet is opened, the second control signal has to be received in addition. By means of this second control signal, the user decides whether gas treatment is to take place or not when the water faucet is opened.

Within the context of the invention, the gas treatment is preferably carbonation, the gas used thus preferably being CO₂. However, for example, oxygenation of the water is also conceivable. The gas source used is preferably a storage vessel such as, for example, a pressure cylinder. The storage vessel can preferably be integrated in the unit which is capable of forming part of the substructure; this unit is thus designed, then, for accommodating the gas cylinder (for example the CO₂ cylinder).

The device for supplying the gas into the mains-water stream preferably has an effervescing chamber, in which a large contact surface area forms between the gas phase and water phase and intensive gas treatment can thus take place. In order to intensify carbonation in particular, use can be made of a carbonator which is known from the prior art.

The apparatus according to the invention may be designed for receiving an additional, second control signal from an external, additional control unit. By means of this external control unit, the user decides whether gas treatment is to take place when the water faucet is opened. The external control unit may be arranged, for example, in the region of the fitting and may have a button which can be pressed to activate the second control signal. Provision may be made here for the second control signal to be triggered only as long as pressure is applied to the button. In the case of this embodiment, the user can start the gas treatment, and bring it to an end again, by pressing the button as the water is running.

As an alternative, it may be provided that the second control signal is triggered, and held, by the button being pressed once for a short period. The second control signal may then prevail, for example, until the water faucet is closed again and the pressure sensor thus brings the first control signal to an end.

Furthermore, it may be provided that, when the button is pressed when the water faucet is still closed, the second control signal is stored in the first instance with a predetermined time constant of, for example 5-30 s, preferably 5-15 s. If the water faucet is opened within this predetermined period of time, the control unit for releasing the gas supply receives both the first control signal from the pressure sensor and the second control signal, which is stored with the predetermined time constant, and releases the gas supply. If, once the button has been pressed, the water faucet is not opened within the predetermined time, the second control signal lapses and, when the water faucet is opened, it is only the first control signal which is present at the control unit for releasing the gas supply, in which case no gas treatment takes place.

The apparatus may be designed for receiving the additional, second control signal in wireless fashion from an external, additional control unit. This embodiment manages without any cable connection between the apparatus, which is designed as a unit which is capable of forming part of the substructure and the additional control unit and thus avoids the situation where holes have to be made, for example, in worktops.

In the case of a preferred embodiment of the invention, the pressure sensor may be designed for emitting the additional, second control signal when it experiences a predetermined pressure sequence. This predetermined pressure sequence may consist, for example, in the water faucet first of all being opened for a short period of time (for example 0.5-10 s, preferably 0.5-5 s, further preferably 1-3 s, preferably approximately 2 s). The water faucet is then closed for a short period of time (preferably approximately 0.2-2 s) and is subsequently immediately opened again. As a result of this pressure sequence, the pressure sensor or an evaluation means, assigned to the pressure sensor, for sensing this pressure sequence emits the second control signal, in which case an effervescing action takes place once the water faucet has been opened for the second time.

An exemplary embodiment of the invention is described hereinbelow with reference to the drawing, which shows, schematically, the construction of an apparatus according to the invention.

A hot-water inflow 1 is connected directly to a water faucet (domestic fitting) 16. The apparatus according to the invention, which is designed as a unit which is capable of forming part of the substructure, is installed between the cold-water inflow 2 and the water faucet 16.

At the in-feed connected to the cold-water inflow 2, this apparatus, in the first instance, has a non-return valve 3, which prevents treated water from flowing back into the fresh-water line. The pressure sensor 4 measures the water pressure in the line and is designed for emitting the first control signal when this pressure drops below a threshold value, the water pressure dropping below this threshold value typically when the water faucet 16 is opened.

The apparatus has six electrically actuatable valves 5, 14, 17, 18, 19 and 20, which can control the water flow in the manner which is explained in more detail hereinbelow.

In the case of a first mode of operation, untreated cold water is withdrawn. In the case of this mode of operation, the valve 5 is closed and the valves 14, 20 are open. The water can then flow, through that branch of the apparatus which is opened by way of the valves 14, 20, directly to the water faucet 16 and withdrawn there. A non-return valve 15 prevents water from flowing back, in this mode of operation, into the effervescing chamber 8.

In the case of a second mode of operation, the valves 14 and 18 are closed, and the valves 5, 17 and 19 are opened. The cold water then flows through the open valve 5 (and the optional pressure reducer 6) and the valve 17 into the effervescing chamber 8. In the effervescing chamber 8, CO₂ is supplied from a CO₂ cylinder 13, which is connected to a cylinder holder 12 of the apparatus. The gaseous CO₂ flows through a pressure reducer, and an electrically actuatable gas valve 10 releases the CO₂ supply into the effervescing chamber 8 via the non-return valve 9, which is provided for safety reasons. In the effervescing chamber 8, the CO₂ supplied mixes with the water supplied via the valve 17. In the case of this mode of operation, carbonated water can be withdrawn from the water faucet 16.

In the case of a third mode of operation, which, within the context of the invention is optional rather than imperative, water withdrawn from the water faucet 16 can also be treated in other ways by means of a connection platform 7. In the case of this third mode of operation, the valves 5, 18 and 19 are open and the valves 14 and 17 are closed. The water flows through the valves 5 and 18 into the connection platform 7. Various additional water-treatment devices may be connected to this connection platform 7. Examples which may be mentioned here are an activated-carbon block for filtering the water and removing, in particular, organic toxins, a UV source for sterilizing the water by means of UV radiation, a cooling means, an ion exchanger for descaling the water, devices for supplying additives, for example drink syrup or the like.

In the state in which it is installed and ready for operation, the apparatus normally assumes the first operating state (default operating state). When the water faucet 16 is opened, the cold water thus flows, through the valve 14, out of the water faucet 16 directly and in an untreated state. When the water faucet 16 is opened, on account of the water pressure dropping below the pressure threshold value, the pressure sensor 4 emits the first control signal, but carbonation does not take place since the second control signal is missing.

If the water faucet 16 is opened for approximately 2 s, closed again briefly (approximately 0.5-2 s) and then immediately opened for a second time, the pressure sensor 4 experiences a corresponding pressure sequence. An electronic control unit (not illustrated in the drawing) records this pressure sequence; it results in the second control signal being generated in this control unit. Once the water faucet 16 has been opened for the second time, both the first and the second control signals are present at this control unit. The control unit then closes the valve 14 and opens the valves 5, 17. Furthermore, the gas valve 10 is opened.

In the effervescing chamber 8, the water flowing through is mixed with carbon dioxide. The action of the carbon dioxide being dissolved in the water is intensified in the carbonator 15, and carbonated mains water then flows out of the water faucet 16.

As an alternative, the second control signal can be generated by an external unit (remote control).

The third mode of operation is merely optional within the context of the invention, and the appropriate equipment may be provided as an option in an apparatus according to the invention. The third mode of operation is usually triggered by additional control signals from the separate control unit (remote control).

Finally, a cleaning operation of the effervescing chamber 8 is also possible as a fourth mode of operation. In the case of this mode of operation, it is possible for the carbonator also to be subjected to the action of water from an outflow for cleaning purposes. In the case of this mode of operation, the valves 5 and 20 are closed and the valves 14 to 19 are open. Water then flows through the valve 14 and 19 into the effervescing chamber, cleans the latter and passes out again via the non-return valve 15.

1. An apparatus for the gas treatment of mains water in the inflow of a domestic fitting, having a connection for a gas source, and having a device for supplying the gas into the mains-water stream, which comprises the following features:
a. the apparatus is designed as a unit which is capable of forming part of the substructure and has a watery inlet, a gas inlet and an outlet for the water or gas-treated water,
b. it has a pressure sensor which is assigned to the water main and is designed for emitting a first control signal when the water pressure drops below a predetermined threshold value,
c. it has a control unit which is intended for releasing the gas supply and is designed for activating the device for supplying the gas into the mains-water stream as soon as it has received the first control signal from the pressure sensor and an additional, second control signal.

2. The apparatus as claimed in claim 1, wherein the gas is CO₂.

3. The apparatus as claimed in claim 1 or 2, wherein the gas source is a storage vessel.

4. The apparatus as claimed in claim 3, wherein the storage vessel can be integrated in the unit which is capable of forming part of the substructure.

5. The apparatus as claimed in claims 1 or 2, wherein the device for supplying the gas into the mains-water stream has an effervescing chamber.

6. The apparatus as claimed in claims 1 or 2, wherein it is designed for receiving an additional, second control signal from an external, additional control unit.

7. The apparatus as claimed in claim 6, wherein it is designed for receiving an additional, second control signal in wireless fashion from an external, additional control unit.

8. The apparatus as claimed in claims 1 or 2, wherein the pressure sensor is designed for emitting the additional, second control signal when it experiences a predetermined pressure sequence.
